(19) United States
(12) Patent Application Publication
(10) Pub. No.: US 2023/0377792 A1
(43) Pub. Date: Nov. 23, 2023

(54) COIL DEVICE

(71) Applicant: TDK CORPORATION, Tokyo (JP)

(72) Inventors: Satoshi SUGIMOTO, Tokyo (JP); Syun ASHIZAWA, Tokyo (JP)

(73) Assignee: TDK CORPORATION, Tokyo (JP)

(21) Appl. No.: 18/319,548

(22) Filed: May 18, 2023

(30) Foreign Application Priority Data
May 23, 2022 (JP) 2022-084009

(51) Int. Cl. H01F 27/29; H01F 27/28

(52) U.S. Cl. CPC H01F 27/292; H01F 27/2828

(57) ABSTRACT

A coil device includes: a core; a coil including a winding portion disposed inside the core, and a lead-out portion led out from the winding portion; and a terminal including a wire connection portion joined to the lead-out portion and disposed inside the core. The wire connection portion is disposed substantially parallel to a winding axis of the coil.

### BACKGROUND OF THE INVENTION

### 1. Field of the Invention

The present application relates to a coil device.

### 2. Description of the Related Art

For example, as illustrated in JP 2018-133403 A, a coil device has been known in which a wire connection portion of a terminal is disposed inside a core. In this type of coil device, since the wire connection portion is not exposed to the outside of the core, the wire connection portion can be protected from the risk of contact with other components.

However, when the wire connection portion is disposed inside the core, the wire connection portion protrudes into a magnetic flux path, so that the wire connection portion blocks the magnetic flux path, which is a concern. In this case, the wire connection portion obstructs a magnetic flux flow, thereby resulting in a deterioration of the inductance characteristics of the coil device, which is a problem.

### CITATION LIST

### Patent Document

Patent Document 1: JP 2018-133403 A

### SUMMARY OF THE INVENTION

The present application is conceived in view of such circumstances, and an object of the present application is to provide a coil device having good inductance characteristics.

In order to achieve the above-described object, according to the present application, there is provided a coil device including:
a core; a coil including a winding portion disposed inside the core, and a lead-out portion led out from the winding portion; and a terminal including a wire connection portion joined to the lead-out portion and disposed inside the core. The wire connection portion is disposed substantially parallel to a winding axis of the coil.

In the coil device according to the present application, the wire connection portion is disposed substantially parallel to the winding axis of the coil. For this reason, the protrusion of the wire connection portion into a magnetic flux path is reduced, so that the overlapping between the wire connection portion and the magnetic flux path is suppressed. Accordingly, the wire connection portion is less likely to obstruct a magnetic flux flow, so that the inductance characteristics of the coil device can be improved.

The wire connection portion may be disposed substantially parallel to one surface or the other surface of the core, the one surface and the other surface facing each other in a direction substantially perpendicular to the winding axis. In this case, the wire connection portion is disposed in a predetermined direction so as to be directed to a region where the magnetic flux is relatively small. For this reason, the protrusion of the wire connection portion into the magnetic flux path is further reduced, so that the wire connection portion is less likely to obstruct the magnetic flux path.

A part of the terminal may be exposed from the one surface or the other surface of the core, and the wire connection portion may be disposed substantially parallel to the one surface or the other surface of the core. In this case, the structure of the wire connection portion can be simplified, and the terminal can be made compact.

An end portion on one side of the wire connection portion with respect to a winding axis direction of the coil may be disposed at a position substantially equal to a position of an end portion on the one side of the coil. In this case, with respect to the winding axis direction of the coil, the range of the wire connection portion in which the lead-out portion can be joined thereto is extended to the position substantially equal to the position of the end portion on the one side of the coil. For this reason, the lead-out portion can be joined to the wire connection portion with relatively high applied pressure, and the joint stability between the lead-out portion and the wire connection portion can be improved.

The lead-out portion may be joined to a first surface of the wire connection portion, which faces the coil. In this case, compared to a case where the lead-out portion is joined to a second surface opposite to the first surface, since the lead-out portion can be led out to the position of the wire connection portion (first surface) over a short distance, the resistance of the lead-out portion can be reduced.

The core may include a corner at which a plurality of surfaces disposed substantially parallel to the winding axis of the coil intersect each other, and at least a part of the wire connection portion may be located at the corner. In this case, at least the part of the wire connection portion is disposed at a position relatively far from the magnetic flux path. For this reason, the protrusion of the wire connection portion into the magnetic flux path is further reduced, so that the wire connection portion is less likely to obstruct the magnetic flux path.

The corner may include a first corner and a second corner located opposite to the first corner along a direction substantially perpendicular to the winding axis of the coil. The wire connection portion may include a first wire connection piece to which the lead-out portion is joined, and a second wire connection piece located opposite to the first wire connection piece along the direction substantially perpendicular to the winding axis of the coil. The first wire connection piece may be disposed at the first corner, and the second wire connection piece may be disposed at the second corner. In this case, the first wire connection piece and the second wire connection piece are disposed at positions relatively far from the magnetic flux path. For this reason, the protrusion of the wire connection portion into the magnetic flux path is further reduced, so that the wire connection portion is less likely to obstruct the magnetic flux path.

The lead-out portion may be biased by an elastic force of the lead-out portion so as to press the wire connection portion. In this case, when the lead-out portion is joined to the wire connection portion, the lead-out portion can be temporarily fixed to the wire connection portion by the elastic force of the lead-out portion.

The lead-out portion may include a joint portion joined to the wire connection portion, the coil may be made of a rectangular wire wound in a flatwise manner, and a wide surface of the rectangular wire may form a joining surface of the joint portion. In this case, the joining area between the joint portion and the wire connection portion is increased, so that the joint stability between the joint portion and the wire connection portion can be improved.

The lead-out portion may include a joint portion joined to the wire connection portion, and a non-joint portion separated from the joint portion, and a first thickness of the joint portion may be smaller than a second thickness of the non-joint portion. In this case, since the joint portion is in the state of being compressed in a thickness direction, the joint portion can be compactly joined to the wire connection portion. Therefore, the volume of the core that can be disposed around the joint portion is increased, so that the inductance characteristics of the coil device can be improved.

A third thickness of the wire connection portion may be larger than the first thickness of the joint portion. In this case, since the third thickness of the wire connection portion becomes relatively large, the physical strength of the wire connection portion can be ensured, so that the joint stability between the joint portion and the wire connection portion can be improved.

A first width of the joint portion may be larger than a second width of the non-joint portion. In this case, since the first width of the joint portion becomes relatively large, the joining area between the joint portion and the wire connection portion is increased, so that the joint stability between the joint portion and the wire connection portion can be improved.

A third width of the wire connection portion may be larger than the first width of the joint portion. In this case, since the third width of the wire connection portion becomes relatively large, the joint portion is less likely to protrude outside the wire connection portion in a width direction, so that the joint stability between the joint portion and the wire connection portion can be improved.

The terminal may include a first terminal and a second terminal. The wire connection portion may include a first wire connection portion provided in the first terminal, and a second wire connection portion provided in the second terminal. The lead-out portion may include a first lead-out portion and a second lead-out portion. The first lead-out portion and the second lead-out portion may be joined to the first wire connection portion and the second wire connection portion, respectively, on the same side in a first direction of the core. In this case, the joining of the first lead-out portion to the first wire connection portion and the joining of the second lead-out portion to the second wire connection portion can be performed in the same direction (the same side in the first direction of the core), so that the manufacturing of the coil device can be facilitated. In addition, deviations in the properties of the coil device can be suppressed by equalizing applied pressures on the first lead-out portion and the second lead-out portion.

The first lead-out portion and the second lead-out portion may be joined to one end portion in the first direction of the first wire connection portion and one end portion in the first direction of the second wire connection portion, respectively. Since the first lead-out portion and the second lead-out portion can be pressure-joined to the first wire connection portion and the second wire connection portion, respectively, with relatively high applied pressures at the one end portion in the first direction of the first wire connection portion and at the one end portion in the first direction of the second wire connection portion, compared to other positions, the joint stability therebetween can be improved.

### BRIEF DESCRIPTION OF THE DRAWINGS

FIG. 1 is a perspective view of a coil device of a first embodiment;

FIG. 2A is a perspective view illustrating an internal configuration of the coil device illustrated in FIG. 1;

FIG. 2AA is a cross-sectional view of a non-joint portion illustrated in FIG. 2A, which is taken along line A-A;

FIG. 2AB is a cross-sectional view of a joint portion illustrated in FIG. 2A, which is taken along line B-B;

FIG. 3 is a perspective view of a coil illustrated in FIG. 2A;

FIG. 4 is a perspective view of terminals illustrated in FIG. 2A;

FIG. 5A is a cross-sectional view of the coil device illustrated in FIG. 2A, which is taken along line VA-VA;

FIG. 5B is a cross-sectional view of a modification example of the coil device illustrated in FIG. 5A;

FIG. 6 is a plan view of the coil device illustrated in FIG. 2A;

FIG. 7A is a cross-sectional view illustrating a peripheral structure of the joint portion illustrated in FIG. 2A;

FIG. 7B is a perspective view illustrating a surface state of the joint portion illustrated in FIG. 7A;

FIG. 7C is a cross-sectional view taken along line VIIC-VIIC illustrated in FIG. 7B;

FIG. 7D is a cross-sectional view of a modification example of the peripheral structure of the joint portion illustrated in FIG. 7A;

FIG. 8A is a view illustrating a method for manufacturing the coil device illustrated in FIG. 1;

FIG. 8B is a view illustrating a step subsequent to FIG. 8A;

FIG. 8C is a view illustrating a step subsequent to FIG. 8B;

FIG. 8D is a view illustrating a step subsequent to FIG. 8C;

FIG. 9 is a perspective view of a coil device of a second embodiment;

FIG. 10 is a perspective view of terminals illustrated in FIG. 9; and

FIG. 11 is a side view of a coil device of a third embodiment.

### DETAILED DESCRIPTION OF THE PREFERRED EMBODIMENTS

Embodiments of the present application will be described with reference to the drawings. The description will be made with reference to the drawings as necessary; however, illustrated contents are merely schematic and exemplary for the understanding of the present application, and the external appearance, dimensional proportions, and the like may differ from the actual product. In addition, hereinafter, the present invention will be specifically described based on the embodiments, but is not limited to these embodiments.

### First Embodiment

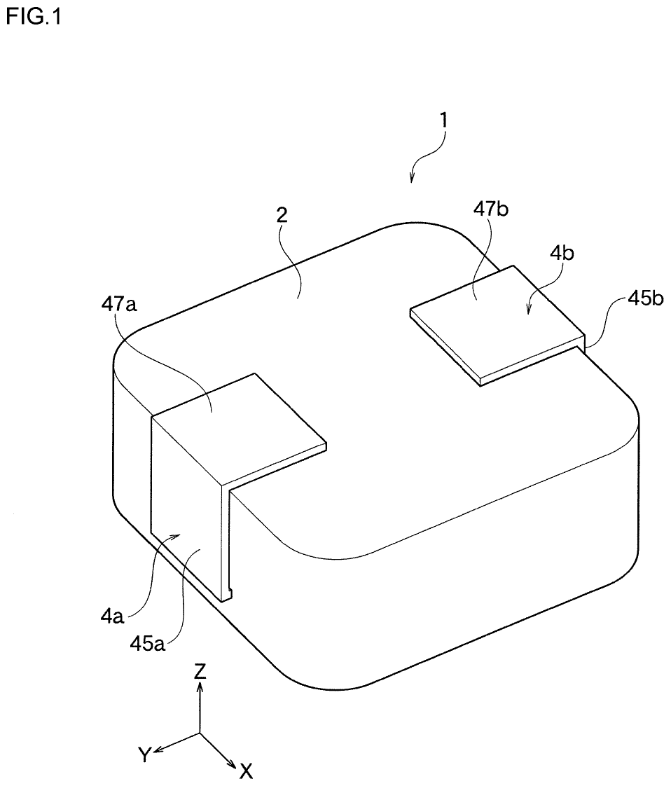

As illustrated in FIG. 1, a coil device 1 of a first embodiment is, for example, a surface-mounted inductor and is mounted on various electronic devices.

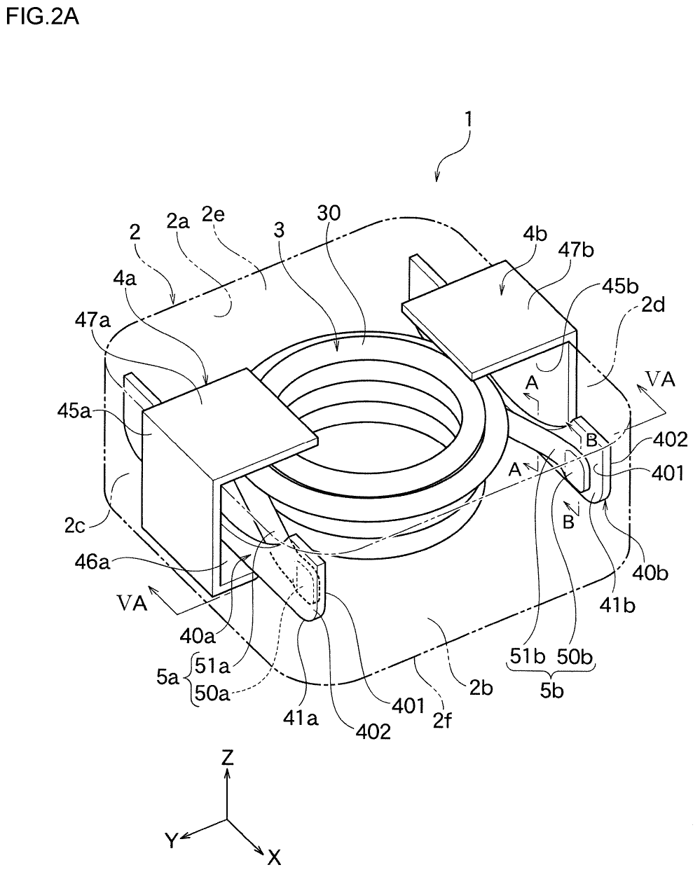

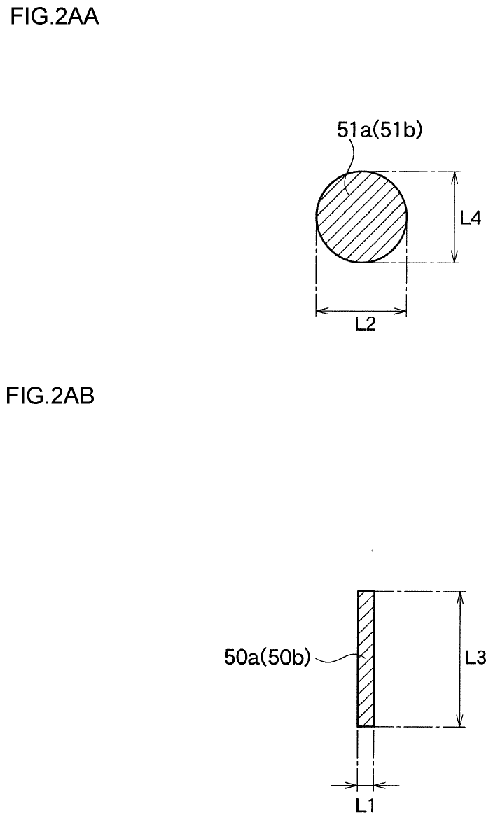

As illustrated in FIG. 2A, the coil device 1 includes a core 2, a coil 3, a terminal 4a, and a terminal 4b. The core 2 has a substantially rectangular parallelepiped shape, and has a first surface 2a, a second surface 2b, a third surface 2c, a fourth surface 2d, a fifth surface 2e, and a sixth surface 2f. Incidentally, in the drawings, a direction in which the first surface 2a and the second surface 2b face each other is defined as an X-axis direction (first direction), a direction in which the third surface 2c and the fourth surface 2d face each other is defined as a Y-axis direction (second direction), and a direction in which the fifth surface 2e and the sixth surface 2f face each other is defined as a Z-axis direction (third direction).

The dimensions of the coil device 1 are not particularly limited, but a length in the X-axis direction of the coil device 1 is, for example, 2 to 20 mm, a length in the Y-axis direction is, for example, 2 to 20 mm, and a length in the Z-axis direction is, for example, 1 to 10 mm.

The core 2 is made of a material containing a magnetic material and a resin. Examples of the magnetic material forming the core 2 include ferrite particles, metallic magnetic particles, and the like. Examples of the ferrite particles include Ni—Zn ferrite particles, Mn—Zn ferrite particles, and the like. The metallic magnetic particles are not particularly limited, but examples of the metallic magnetic particles include Fe—Ni alloy powder, Fe—Si alloy powder, Fe—Si—Cr alloy powder, Fe—Co alloy powder, Fe—Si—Al alloy powder, amorphous iron, and the like. The resin forming the core 2 is not particularly limited, but examples of the resin include epoxy resin, phenol resin, polyester resin, polyurethane resin, polyimide resin, other synthetic resins, other non-magnetic materials, and the like. The core 2 may be a sintered body of a metallic magnetic material.

The core 2 is formed by powder compaction molding, injection molding, or the like. The shape of the core 2 is not limited to a substantially rectangular parallelepiped shape, and may have another polygonal shape or a substantially columnar shape. In addition, the core 2 may be formed by combining (compression molding) a plurality of green compacts (a plurality of layers).

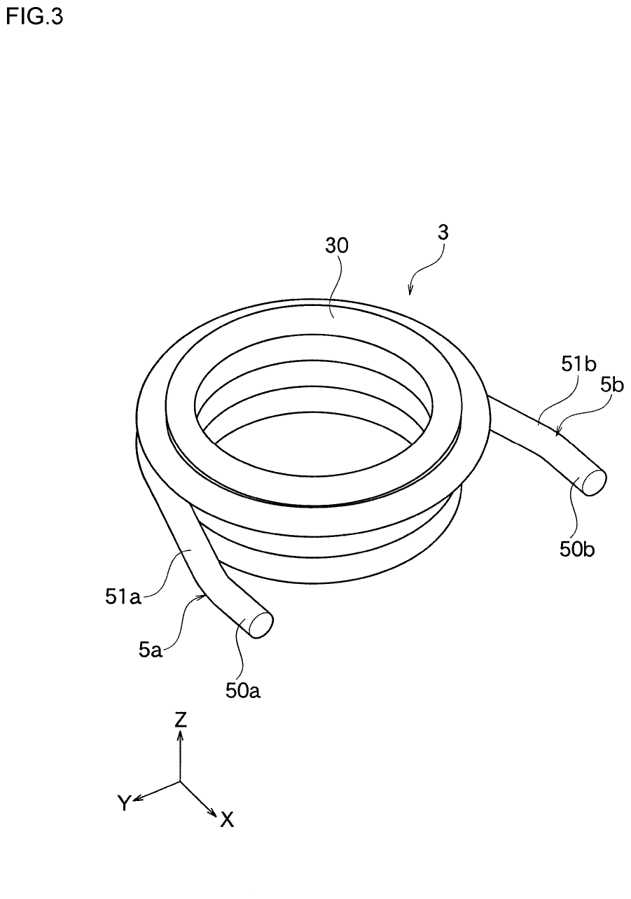

As illustrated in FIG. 3, the coil 3 is a coreless coil and is made of a round wire coated with insulation. Copper, silver, an alloy containing these metals, other metals, or other alloys are used as the material of the wire. A diameter of the wire is, for example, 10 to 80 μm. At least a part (for example, a lead-out portion 5a and a lead-out portion 5b) of the wire may be exposed from the insulation coating. A winding axis direction of a winding portion 30 of the coil 3 corresponds to the Z-axis direction, and is a direction orthogonal to the fifth surface 2e and the sixth surface 2f of the core 2 (FIG. 2A). The number of windings of the winding portion 30 is not particularly limited and may be one turn or more.

As illustrated in FIG. 2A, the coil 3 is embedded inside the core 2. The coil 3 includes the winding portion 30 formed by winding the wire; the lead-out portion 5a extending from the winding portion 30 to one end of the wire; and the lead-out portion 5b extending from the winding portion 30 to the other end of the wire.

The lead-out portion 5a includes a joint portion 50a joined to the terminal 4a, and a non-joint portion 51a not joined to the terminal 4a. The non-joint portion 51a is a portion located between the winding portion 30 and the joint portion 50a of the coil 3 (portion located at a position separated from the joint portion 50a). The lead-out portion 5b includes a joint portion 50b joined to the terminal 4b, and a non-joint portion 51b not joined to the terminal 4b. The non-joint portion 51b is a portion located between the winding portion 30 and the joint portion 50b of the coil 3 (portion located at a position separated from the joint portion 50b).

The lead-out portion 5a is led out toward the second surface 2b of the core 2. Similarly, the lead-out portion 5b is led out toward the second surface 2b of the core 2. Namely, in the present embodiment, lead-out directions of the lead-out portion 5a and the lead-out portion 5b are the same. However, the lead-out directions may be opposite with respect to the X-axis direction. The lead-out portion 5a and the lead-out portion 5b are joined to the terminal 4a and the terminal 4b, respectively.

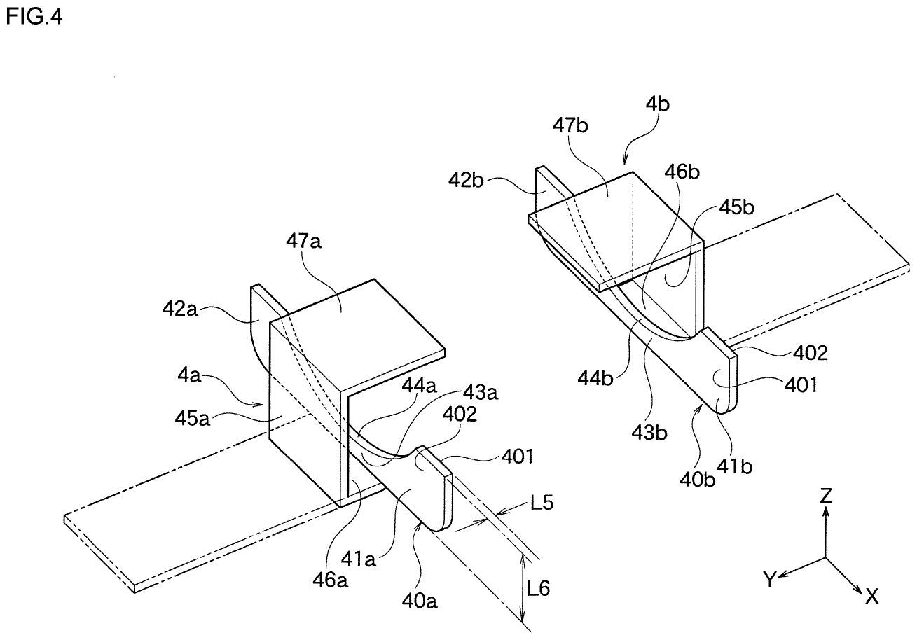

The terminal 4a and the terminal 4b are disposed with a separation from each other in the Y-axis direction. As illustrated in FIG. 4, the terminal 4a includes a wire connection portion 40a, a first connection portion 45a, a second connection portion 46a, and an external electrode portion 47a, but is not limited thereto, and as one embodiment, the terminal 4a may include only the wire connection portion 40a. In addition, the terminal 4b includes a wire connection portion 40b, a first connection portion 45b, a second connection portion 46b, and an external electrode portion 47b, but is not limited thereto, and as one embodiment, the terminal 4b may include only the wire connection portion 40b. The terminal 4a and the terminal 4b may have the same shape or may have different shapes.

As illustrated in FIG. 2A, the external electrode portion 47a and the external electrode portion 47b are disposed on the fifth surface 2e of the core 2 with a separation from each other in the Y-axis direction. For example, the coil device 1 may be mounted on an external substrate via the external electrode portion 47a and the external electrode portion 47b. For example, the external electrode portion 47a and the external electrode portion 47b may be connected to a land pattern of the external substrate by a solder, conductive adhesive agent, or the like.

The first connection portion 45a is disposed on the third surface 2c of the core 2, and is orthogonal to the external electrode portion 47a. The first connection portion 45a extends along the Z-axis direction on the third surface 2c. The first connection portion 45b is disposed on the fourth surface 2d of the core 2, and is orthogonal to the external electrode portion 47b. The first connection portion 45b extends with a predetermined length on the fourth surface 2d. The first connection portion 45a and the first connection portion 45b face each other in the Y-axis direction.

A length in the Z-axis direction of the first connection portion 45a is shorter than a length in the Z-axis direction of the core 2. A length in the Z-axis direction of the first connection portion 45b is shorter than a length in the Z-axis direction of the core 2. For example, solder fillets can be formed on the first connection portion 45a and the first connection portion 45b.

The second connection portion 46a is disposed inside the core 2, and is orthogonal to the first connection portion 45a. The second connection portion 46b is disposed inside the core 2, and is orthogonal to the first connection portion 45b. Incidentally, a connection portion of the second connection portion 46a to the first connection portion 45a is exposed from the core 2, and the other portions are disposed inside the core 2. Similarly, a connection portion of the second connection portion 46b to the first connection portion 45b is exposed from the core 2, and the other portions are disposed inside the core 2.

Lengths in the X-axis direction of the first connection portion 45a, the second connection portion 46a, and the external electrode portion 47a are substantially equal but may be different. In the present embodiment, the length in the X-axis direction of each of the first connection portion 45a, the second connection portion 46a, and the external electrode portion 47a is, for example, less than or equal to ½ of a width in the X-axis direction of the core 2.

Lengths in the X-axis direction of the first connection portion 45b, the second connection portion 46b, and the external electrode portion 47b are substantially equal but may be different. In the present embodiment, the length in the X-axis direction of each of the first connection portion 45b, the second connection portion 46b, and the external electrode portion 47b is, for example, less than or equal to ½ of the width in the X-axis direction of the core 2.

The wire connection portion 40a and the wire connection portion 40b have a flat plate shape and are disposed inside the core 2. The joint portion 50a of the lead-out portion 5a is joined to at least a part of the wire connection portion 40a, and the joint portion 50b of the lead-out portion 5b is joined to at least a part of the wire connection portion 40b.

The wire connection portion 40a is connected to the external electrode portion 47a via the first connection portion 45a and the second connection portion 46a. The wire connection portion 40b is connected to the external electrode portion 47b via the first connection portion 45b and the second connection portion 46b.

The wire connection portion 40a is disposed parallel to the third surface 2c of the core 2, on which the first connection portion 45a is exposed. The wire connection portion 40b is disposed parallel to the fourth surface 2d of the core 2, on which the first connection portion 45b is exposed. In addition, the wire connection portions 40a and 40b are disposed parallel to a winding axis of the coil 3. Incidentally, in the present embodiment, “parallel” is defined to allow for variations within ±5%.

The wire connection portion 40a and the wire connection portion 40b are disposed perpendicular to the sixth surface 2f of the core 2 so as to be directed toward a region where the magnetic flux is relatively small. For this reason, the protrusion of the wire connection portion 40a and the wire connection portion 40b (particularly, end portions on a positive Z-axis direction side of the wire connection portion 40a and the wire connection portion 40b) into a magnetic flux path is reduced, so that the wire connection portion 40a and the wire connection portion 40b become less likely to obstruct the magnetic flux path. Incidentally, in the present embodiment, “perpendicular” is defined to allow for variations within ±5%.

In addition, for example, compared to a case where the wire connection portion 40a and the wire connection portion 40b are disposed parallel to the second surface 2b of the core 2, the structure of the wire connection portion 40a and the wire connection portion 40b can be simplified, and the terminal 4a and the terminal 4b can be made compact.

Each of the wire connection portion 40a and the wire connection portion 40b has a first surface 401 that is a surface facing the coil 3, and a second surface 402 that is a surface facing opposite to the coil 3. The first surface 401 and the second surface 402 are disposed parallel to the third surface 2c and the fourth surface 2d of the core 2.

As illustrated in FIG. 4, the wire connection portion 40a includes a first wire connection piece 41a, a second wire connection piece 42a, an intermediate portion 43a, and a curved portion 44a. In addition, the wire connection portion 40b includes a first wire connection piece 41b, a second wire connection piece 42b, an intermediate portion 43b, and a curved portion 44b.

The curved portion 44a is formed at a portion of an outer edge portion of the wire connection portion 40a, the portion being located on a side that is opposite to a side, on which the second connection portion 46a is connected to the wire connection portion 40a, in the Z-axis direction. The curved portion 44a may be formed, for example, across the first wire connection piece 41a, the intermediate portion 43a, and the second wire connection piece 42a.

The curved portion 44b is formed at a portion of an outer edge portion of the wire connection portion 40b, the portion being located on a side that is opposite to a side, on which the second connection portion 46b is connected to the wire connection portion 40b, in the Z-axis direction. The curved portion 44b may be formed, for example, across the first wire connection piece 41b, the intermediate portion 43b, and the second wire connection piece 42b.

The intermediate portion 43a is located between the first wire connection piece 41a and the second wire connection piece 42a along the X-axis direction, and connects the first wire connection piece 41a and the second wire connection piece 42a. The intermediate portion 43b is located between the first wire connection piece 41b and the second wire connection piece 42b along the X-axis direction, and connects the first wire connection piece 41b and the second wire connection piece 42b.

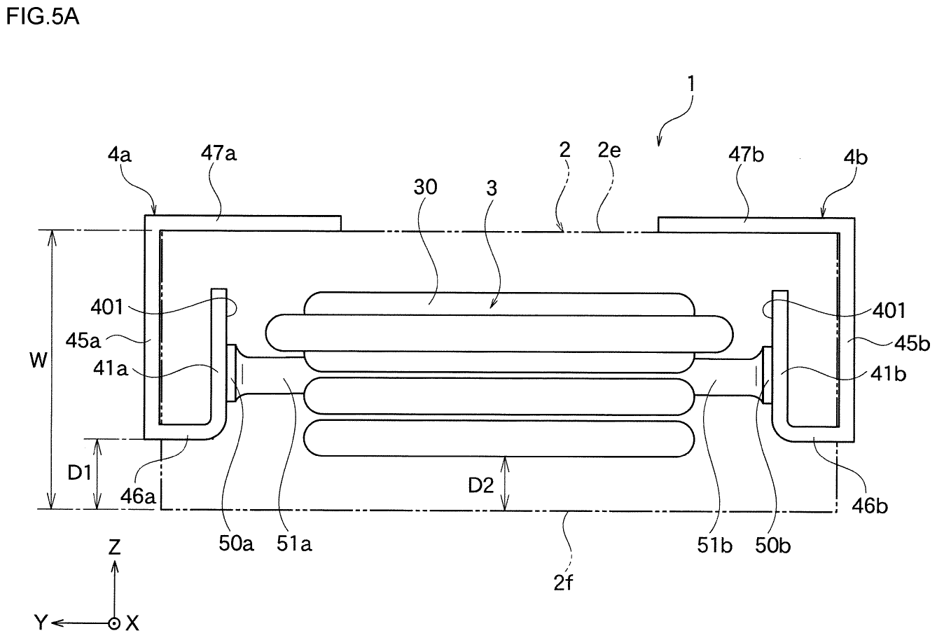

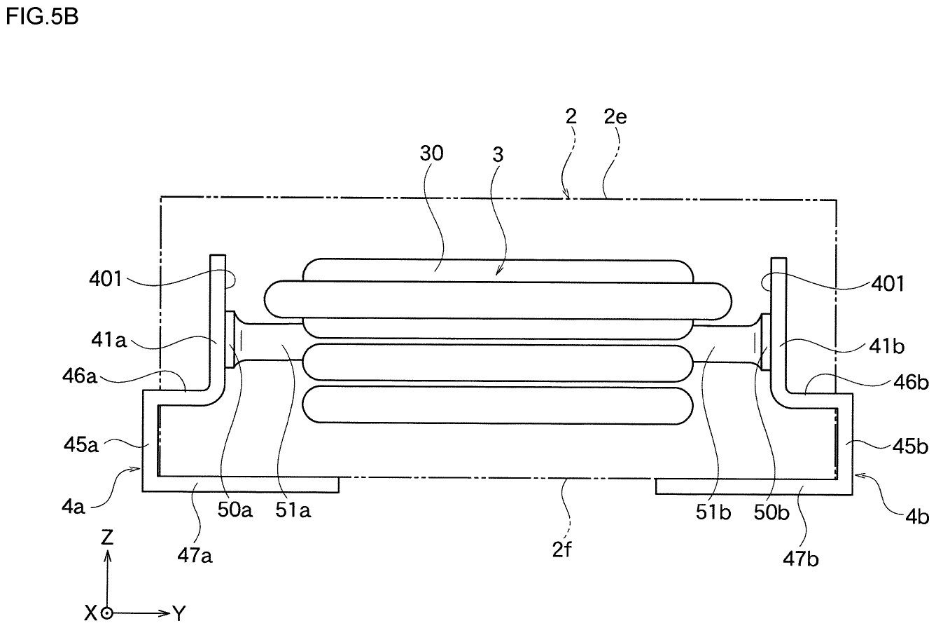

The first wire connection piece 41a and the second wire connection piece 42a have the same shape, but may have different shapes. In addition, the first wire connection piece 41b and the second wire connection piece 42b have the same shape, but may have different shapes. As illustrated in FIG. 5A, an end portion on a sixth surface 2f side of each of the first wire connection piece 41a and the first wire connection piece 41b is disposed at a position separated from the sixth surface 2f of the core 2 by a distance D1 in the Z-axis direction. The distance D1 is, for example, ⅛ or more and less than ½ of a width W in the Z-axis direction of the core 2. When a distance between the sixth surface 2f of the core 2 and an end portion of the coil 3 located on the sixth surface 2f side in the Z-axis direction is defined as D2, D1 D2 may be satisfied.

With respect to the Z-axis direction, end portions on the positive Z-axis direction side of the first wire connection piece 41a and the first wire connection piece 41b are disposed at a position substantially equal to that of an end portion on the positive Z-axis direction side of the winding portion 30. For this reason, with respect to the Z-axis direction, the range of the first wire connection piece 41a and the first wire connection piece 41b in which the joint portion 50a and the joint portion 50b can be joined thereto is extended to the position substantially equal to that of the end portion on the positive Z-axis direction side of the winding portion 30. For this reason, the joint portion 50a and the joint portion 50b can be joined to the first wire connection piece 41a and the first wire connection piece 41b, respectively, with relatively high applied pressure, and the joint stability therebetween can be improved. Incidentally, the end portions on the positive Z-axis direction side of the first wire connection piece 41a and the first wire connection piece 41b may be located closer to a fifth surface 2e side of the core 2 than the end portion on the positive Z-axis direction side of the winding portion 30. In addition, the position substantially equal to that of the end portion on the positive Z-axis direction side of the winding portion 30 includes a variation of one to two turns of the wire.

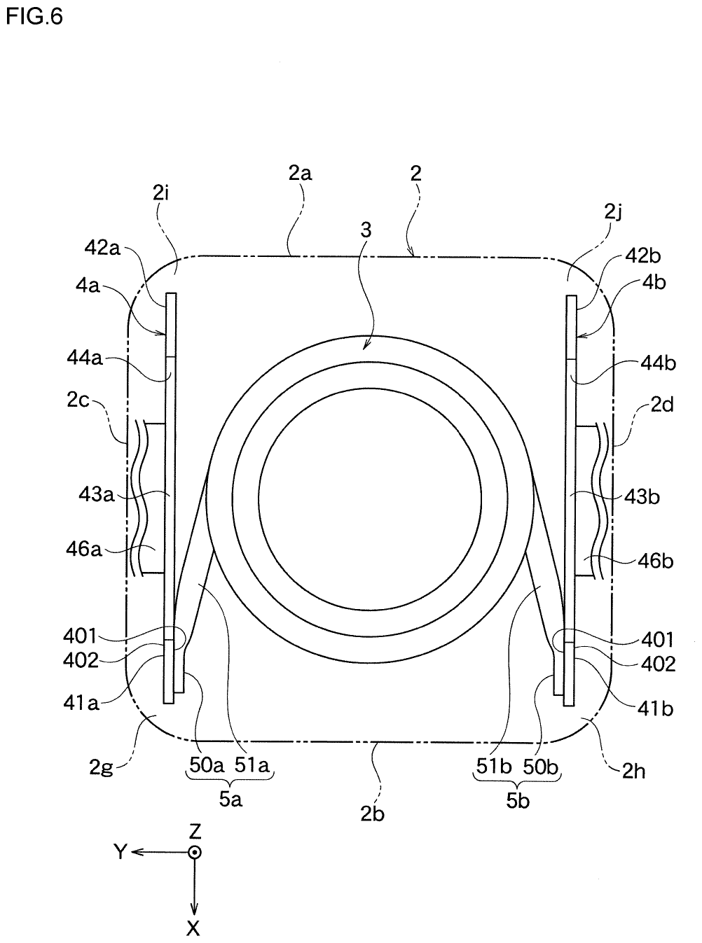

As illustrated in FIG. 6, the joint portion 50a of the lead-out portion 5a may be joined to one side (one end portion in the X-axis direction of the wire connection portion 40a) with respect to the center in the X-axis direction of the first wire connection piece 41a. In addition, the joint portion 50b of the lead-out portion 5b may be joined to one side (one end portion in the X-axis direction of the wire connection portion 40b) with respect to the center in the X-axis direction of the first wire connection piece 41b. Since the joint portion 50a and the joint portion 50b can be pressure-joined to the first wire connection piece 41a and the first wire connection piece 41b with relatively high applied pressures at such positions compared to other positions, the joint stability therebetween can be improved.

In addition, both the joint portion 50a and the joint portion 50b may be joined to the first wire connection piece 41a and the first wire connection piece 41b on the same side (second surface 2b side) in the X-axis direction of the core 2. In this case, the joining of the joint portion 50a to the first wire connection piece 41a and the joining of the joint portion 50b to the first wire connection piece 41b can be performed in the same direction (the same side in the X-axis direction). Therefore, the manufacturing of the coil device 1 can be facilitated, and manufacturing deviations of the coil device 1 can be suppressed by equalizing the applied pressures on the joint portion 50a and the joint portion 50b.

The first wire connection piece 41a (particularly, a joint position between the joint portion 50a and the first wire connection piece 41a) may be located in the vicinity of an intersection portion between the second surface 2b and the third surface 2c of the core 2 (corner 2g of the core 2). For example, the first wire connection piece 41a (particularly, the joint position between the joint portion 50a and the first wire connection piece 41a) may be located within a range of 40% of a width in the X-axis direction of the third surface 2c (alternatively, a width in the Y-axis direction of the second surface 2b), or may be located within a range of 30% of the width in the X-axis direction of the third surface 2c (alternatively, the width in the Y-axis direction of the second surface 2b), with the intersection portion as the center.

In addition, the first wire connection piece 41b (particularly, a joint position between the joint portion 50b and the first wire connection piece 41b) may be located in the vicinity of an intersection portion between the second surface 2b and the fourth surface 2d of the core 2 (corner 2h of the core 2). For example, the first wire connection piece 41b (particularly, the joint position between the joint portion 50b and the first wire connection piece 41b) may be located within a range of 40% of a width in the X-axis direction of the fourth surface 2d (alternatively, the width in the Y-axis direction of the second surface 2b), or may be located within a range of 30% of the width in the X-axis direction of the fourth surface 2d (alternatively, the width in the Y-axis direction of the second surface 2b), with the intersection portion as the center.

By disposing the first wire connection piece 41a and the first wire connection piece 41b at the corner 2g and the corner 2h of the core 2, respectively, the first wire connection piece 41a and the first wire connection piece 41b are disposed at positions relatively far from the magnetic flux path. Therefore, the protrusion of the first wire connection piece 41a and the first wire connection piece 41b into the magnetic flux path is reduced, so that the first wire connection piece 41a and the first wire connection piece 41b are less likely to obstruct the magnetic flux path.

The second wire connection piece 42a may be located in the vicinity of an intersection portion between the first surface 2a and the third surface 2c of the core 2 (corner 2i of the core 2). For example, the second wire connection piece 42a may be located within a range of 40% of the width in the X-axis direction of the third surface 2c (alternatively, a width in the Y-axis direction of the first surface 2a), or may be located within a range of 30% of the width in the X-axis direction of the third surface 2c (alternatively, the width in the Y-axis direction of the first surface 2a), with the intersection portion as the center.

In addition, the second wire connection piece 42b may be located in the vicinity of an intersection portion between the first surface 2a and the fourth surface 2d of the core 2 (corner 2j of the core 2). For example, the second wire connection piece 42b may be located within a range of 40% of the width in the X-axis direction of the fourth surface 2d (alternatively, the width in the Y-axis direction of the first surface 2a), or may be located within a range of 30% of the width in the X-axis direction of the fourth surface 2d (alternatively, the width in the Y-axis direction of the first surface 2a), with the intersection portion as the center.

In this case, the first wire connection piece 41a and the first wire connection piece 41b are disposed at the corner 2g and the corner 2h, respectively, and the second wire connection piece 42a and the second wire connection piece 42b are disposed at the corner 2i and the corner 2j, respectively. For this reason, both the first wire connection piece 41a and the first wire connection piece 41b and both the second wire connection piece 42a and the second wire connection piece 42b are disposed at positions relatively far from the magnetic flux path. As a result, the protrusion of the first wire connection piece 41a, the first wire connection piece 41b, the second wire connection piece 42a, and the second wire connection piece 42b into the magnetic flux path is further reduced, so that the first wire connection piece 41a, the first wire connection piece 41b, the second wire connection piece 42a, and the second wire connection piece 42b are less likely to obstruct the magnetic flux path.

The lead-out portion 5a may be biased by an elastic force of the lead-out portion 5a so as to press the first wire connection piece 41a. In addition, the lead-out portion 5b may be biased by an elastic force of the lead-out portion 5b so as to press the first wire connection piece 41b. In this case, when the joint portion 50a and the joint portion 50b are joined to the first wire connection piece 41a and the first wire connection piece 41b, the joint portion 50a and the joint portion 50b can be temporarily fixed to the first wire connection piece 41a and the first wire connection piece 41b by the elastic forces of the lead-out portion 5a and the lead-out portion 5b.

The joint portion 50a and the joint portion 50b may be joined to the first surfaces 401 (surfaces facing the coil 3) of the first wire connection piece 41a and the first wire connection piece 41b, respectively. In this case, compared to a case where the joint portion 50a and the joint portion 50b are joined to the second surfaces 402 of the first wire connection piece 41a and the first wire connection piece 41b, respectively, since the joint portion 50a and the joint portion 50b can be led out to the positions of the first wire connection piece 41a and the first wire connection piece 41b over a short distance, the resistance of the lead-out portion 5a and the lead-out portion 5b can be reduced.

As illustrated in FIG. 2AB, in a cross section orthogonal to an extending direction (X-axis direction) of the joint portion 50a and the joint portion 50b (Y-Z cross section), the joint portion 50a and the joint portion 50b have a flattened shape.

On the other hand, as illustrated in FIG. 2AA, in a cross section orthogonal to an extending direction of the non-joint portion 51a and the non-joint portion 51b, the non-joint portion 51a and the non-joint portion 51b have a substantially circular wire shape. Incidentally, the non-joint portion 51a and the non-joint portion 51b may be deformed into, for example, a substantially elliptical shape (substantially elliptical shape having a major axis in a width direction) in the vicinity of the joint portion 50a and the joint portion 50b.

In the present embodiment, since a cross-sectional area of the joint portion 50a is smaller than a cross-sectional area of the non-joint portion 51a, the joining area between the joint portion 50a and the first wire connection piece 41a is increased, so that an improvement in connection stability therebetween is expected. Similarly, since a cross-sectional area of the joint portion 50b is smaller than a cross-sectional area of the non-joint portion 51b, the joining area between the joint portion 50b and the first wire connection piece 41b is increased, so that an improvement in connection stability therebetween is expected.

As illustrated in FIGS. 2AA and 2AB, a thickness L1 of the joint portion 50a and the joint portion 50b is smaller than a thickness L2 of the non-joint portion 51a and the non-joint portion 51b. The reason for this is that the joint portion 50a and the joint portion 50b are compressed in a thickness direction when joined to the first wire connection piece 41a and the first wire connection piece 41b.

Incidentally, the thickness L1 of the joint portion 50a is a length in the Y-axis direction between a joining surface of the joint portion 50a joined to the first wire connection piece 41a and a surface of the joint portion 50a opposite to the joining surface in the Y-axis direction. In addition, the thickness L1 of the joint portion 50b is a length in the Y-axis direction between a joining surface of the joint portion 50b joined to the first wire connection piece 41b and a surface of the joint portion 50b opposite to the joining surface in the Y-axis direction. The thickness L2 of the non-joint portion 51a is a length in a direction corresponding to the thickness L1 of the joint portion 50a illustrated in FIG. 2AB, in a cross section orthogonal to the extending direction of the non-joint portion 51a illustrated in FIG. 2AA. In addition, the thickness L2 of the non-joint portion 51b is a length in the direction corresponding to the thickness L1 of the joint portion 50b illustrated in FIG. 2AB, in a cross section orthogonal to the extending direction of the non-joint portion 51b illustrated in FIG. 2AA.

An aspect ratio L3/L1 of the joint portion 50a may be, for example, 1<L3/L1≤10 or 1<L3/L1≤5. By applying pressure to the joint portion 50a and the joint portion 50b so as to make the value of L3/L1 fall within the above-described range, the joint strengths between the joint portion 50a and the first wire connection piece 41a and between the joint portion 50b and the first wire connection piece 41b can be improved.

A length ratio L1/L2 of the joint portion 50a (50b) and the non-joint portion 51a (51b) may be, for example, 1/50≤L1/L2<1 or may be, for example, 1/50 L1/L2<½. By applying pressure to the joint portion 50a and the joint portion 50b so as to make the value of L1/L2 fall within the above-described range, the joint strengths between the joint portion 50a and the first wire connection piece 41a and between the joint portion 50b and the first wire connection piece 41b can be improved.

A width L3 of the joint portion 50a and the joint portion 50b is larger than a width L4 of the non-joint portion 51a and the non-joint portion 51b. As described above, the reason for this is that the joint portion 50a and the joint portion 50b are compressed in the thickness direction, and as a result, the joint portion 50a and the joint portion 50b are rolled in the width direction.

Incidentally, the width L3 of the joint portion 50a is a length in the Z-axis direction of the joint portion 50a (length of the joint portion 50a in a direction orthogonal to the thickness direction). In addition, the width L3 of the joint portion 50b is a length in the Z-axis direction of the joint portion 50b (length of the joint portion 50b in the direction orthogonal to the thickness direction). The width L4 of the non-joint portion 51a is a length in a direction corresponding to the width L3 of the joint portion 50a illustrated in FIG. 2AB, in a cross section orthogonal to the extending direction of the non-joint portion 51a illustrated in FIG. 2AA. In addition, the width L4 of the non-joint portion 51b is a length in the direction corresponding to the width L3 of the joint portion 50b illustrated in FIG. 2AB, in a cross section orthogonal to the extending direction of the non-joint portion 51b illustrated in FIG. 2AA.

A length ratio L3/L4 of the joint portion 50a (50b) and the non-joint portion 51a (51b) may be, for example, 1<L3/L4≤5 or may be, for example, 1<L3/L4≤3. By applying pressure to the joint portion 50a and the joint portion 50b so as to make the value of L3/L4 fall within the above-described range, the joint strengths between the joint portion 50a and the first wire connection piece 41a and between the joint portion 50b and the first wire connection piece 41b can be improved. In addition, the joining areas between the joint portion 50a and the first wire connection piece 41a and between the joint portion 50b and the first wire connection piece 41b are increased, so that the joint stability therebetween can be improved.

A thickness L5 of the first wire connection piece 41a and the first wire connection piece 41b (FIG. 4) is larger than the thickness L1 of the joint portion 50a and the joint portion 50b. A length ratio L5/L1 of the first wire connection piece 41a (41b) and the joint portion 50a (50b) is, for example, 2≤L5/L1≤20. In this case, the thickness of the first wire connection piece 41a and the first wire connection piece 41b becomes relatively large. For this reason, the physical strength of the first wire connection piece 41a and the first wire connection piece 41b can be further ensured, so that the joint stability between the joint portion 50a and the first wire connection piece 41a and between the joint portion 50b and the first wire connection piece 41b can be improved.

Incidentally, the thickness L5 of the first wire connection piece 41a is a length in the Y-axis direction (direction orthogonal to the first surface 401) of the first wire connection piece 41a. In addition, the thickness L5 of the first wire connection piece 41b is a length in the Y-axis direction (direction orthogonal to the first surface 401) of the first wire connection piece 41b.

A width L6 of the first wire connection piece 41a and the first wire connection piece 41b (FIG. 4) may be larger than the width L3 of the joint portion 50a and the joint portion 50b. In this case, the joint portion 50a and the joint portion 50b are less likely to protrude outside the first wire connection piece 41a and the first wire connection piece 41b in the width direction, so that the joint stability therebetween can be improved.

Incidentally, the width L6 of the first wire connection piece 41a is a length in the Z-axis direction (direction in which the fifth surface 2e and the sixth surface 2f of the core 2 face each other) of the first wire connection piece 41a. In addition, the width L6 of the first wire connection piece 41b is a length in the Z-axis direction (direction in which the fifth surface 2e and the sixth surface 2f of the core 2 face each other) of the first wire connection piece 41b.

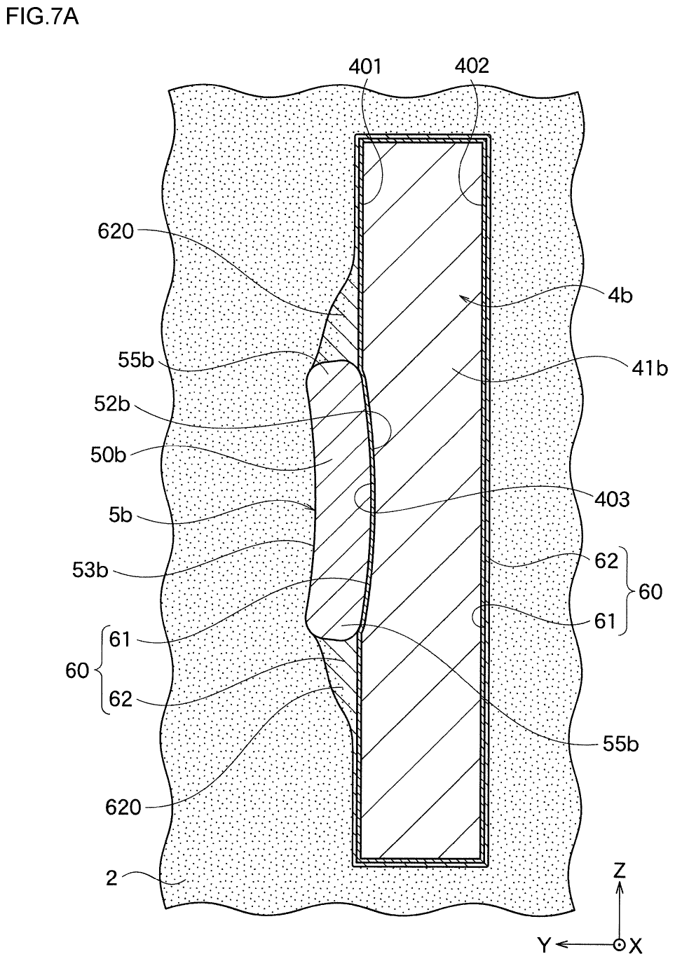

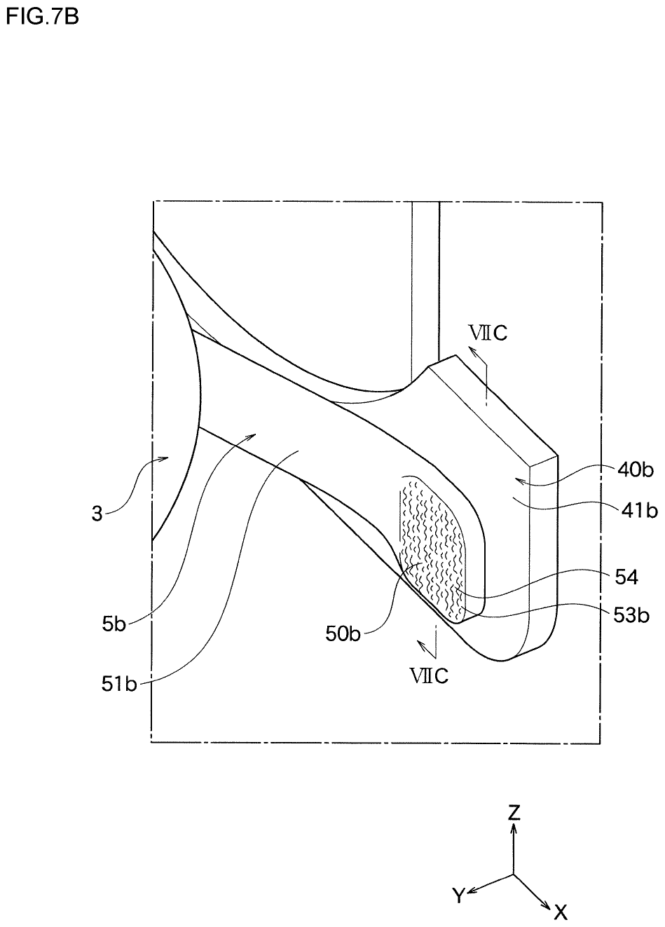

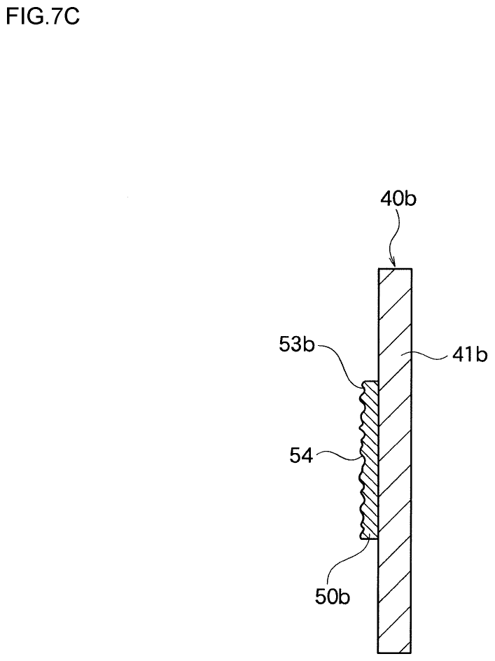

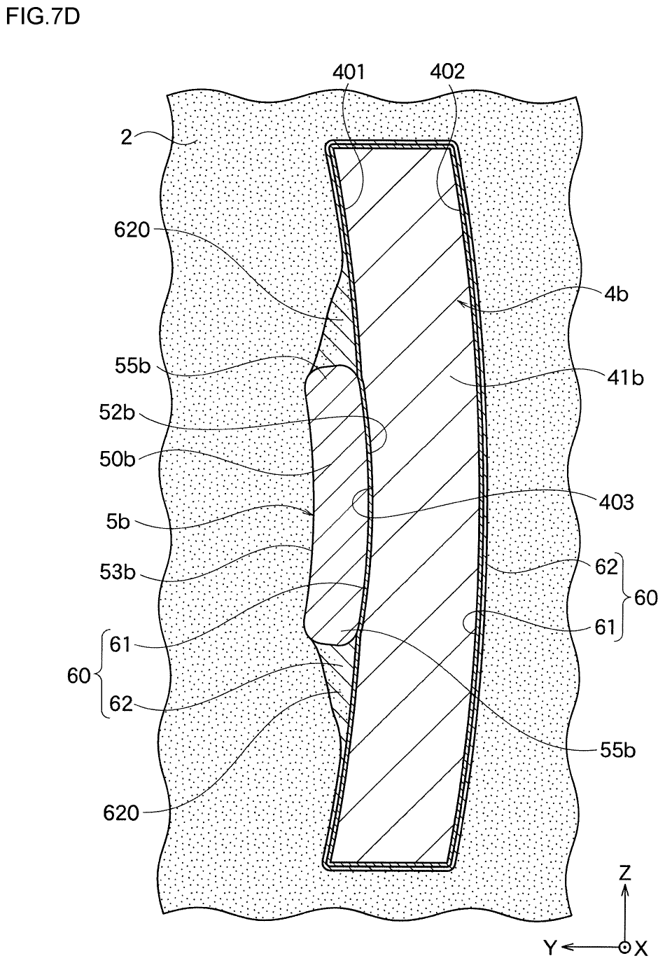

As illustrated in FIG. 7A, a metal layer 60 is formed on a surface of the terminal 4b. Similarly, the metal layer 60 is formed on a surface of the terminal 4a. The metal layer 60 includes a first metal layer 61 and a second metal layer 62 different from the first metal layer 61, and has a laminated structure. The first metal layer 61 and the second metal layer 62 are made of, for example, plating films and are made of metal such as Sn, Au, Ni, Pt, Ag, and Pd or alloys of these metals. For example, the first metal layer 61 contains Ni, and the second metal layer 62 contains Sn. Ni has an effect of preventing corrosion of the metal. When the joint portion 50a and the joint portion 50b are pressure-joined to the first wire connection piece 41a and the first wire connection piece 41b, respectively, Sn has an effect of improving peel strength therebetween. Incidentally, the metal layer 60 may be formed by other thin film methods such as sputtering. The thickness of the metal layer 60 may be 3 to 30 μm.

Of the first metal layer 61 and the second metal layer 62, at least the first metal layer 61 exists between the joint portion 50b and the first wire connection piece 41b. The first metal layer 61 connects the joint portion 50b and the first wire connection piece 41b. The first metal layer 61 located between the joint portion 50b and the first wire connection piece 41b acts to improve the joint strength therebetween.

The second metal layer 62 is present at end portions in the Z-axis direction (width direction) of the joint portion 50b, and the second metal layer 62 covers at least a part of the end portions in the Z-axis direction of the joint portion 50b. Hereinafter, the second metal layer 62 covering at least the part of the end portions in the Z-axis direction of the joint portion 50b is referred to as an “adhesion portion 620”. The adhesion portion 620 is obtained when the joint portion 50b and the first wire connection piece 41b are joined, for example, by thermocompression joining.

Namely, when the joint portion 50b and the first wire connection piece 41b are joined, for example, the adhesion portion 620 is obtained by the second metal layer 62 therebetween being pushed out toward the end portions in the Z-axis direction of the joint portion 50b. Incidentally, in addition to this, after the joint portion 50b is joined to the first wire connection piece 41b, a process of forming the adhesion portion 620 at the end portions in the Z-axis direction of the joint portion 50b may be separately performed.

The thickness of the adhesion portion 620 increases toward the joint portion 50b along the Z-axis direction. The adhesion portion 620 acts to improve the joint strength between the joint portion 50b and the first wire connection piece 41b. Incidentally, a part of the adhesion portion 620 may adhere to a surface 53b of the joint portion 50b.

In the viewpoint of improving the joint strength between the joint portion 50b and the first wire connection piece 41b, the thickness (maximum thickness or average thickness) of the second metal layer 62 on the first surface 401 of the first wire connection piece 41b may be larger than the thickness (maximum thickness or average thickness) of the second metal layer 62 on the second surface 402.

A part (magnetic particles or the like) of the core 2 may be incorporated into the inside of the adhesion portion 620. In this case, the volume of the core 2 disposed around the end portions in the Z-axis direction of the joint portion 50b is increased, so that the inductance characteristics of the coil device 1 can be improved.

The first surface 401 of the first wire connection piece 41b joined to the joint portion 50b includes a concave portion 403. The concave portion 403 exists within the joining range of the first surface 401 facing a joining surface 52b. The concave portion 403 is curved along the shape of the joining surface 52b facing the first surface 401.

For example, during thermocompression joining, the concave portion 403 is obtained by pushing the joint portion 50b against the first surface 401 and applying pressure thereto using a jig. At this time, as illustrated in FIG. 7D, the concave portion 403 may be formed on the first surface 401, and the first wire connection piece 41b may be curved. Since the concave portion 403 exists on the first surface 401 at the position of the joint portion 50b, the joining area between the joint portion 50b and the first wire connection piece 41b is increased, so that the joint strength therebetween can be improved.

The joint portion 50b has an arc shape in a Y-Z cross section. Each end portion 55b in the Z-axis direction of the joint portion 50b is bent in a direction away from the first surface 401 of the first wire connection piece 41b (toward a positive Y-axis direction side). In addition, a central portion in the Z-axis direction of the joint portion 50b is concave toward a second surface 402 side of the first wire connection piece 41b. For this reason, the joining area between the joint portion 50b and the first wire connection piece 41b is increased, so that the joint strength therebetween can be improved.

As illustrated in FIGS. 7B and 7C, irregularities 54 are formed on the surface 53b (surface located opposite to the joining surface 52b illustrated in FIG. 7A in the Y-axis direction) of the joint portion 50b. Similarly, the irregularities 54 are formed on a surface of the joint portion 50a. The irregularities 54 may be formed entirely on the surface 53b or may be formed locally thereon.

Since the irregularities 54 are formed on the surface 53b of the joint portion 50b, a surface roughness (arithmetic mean height) of the surface 53b of the joint portion 50b is larger than a surface roughness (arithmetic mean height) of a surface of the non-joint portion 51b (FIG. 2A). In addition, an area of the surface 53b of the joint portion 50b is larger than an area of the surface of the non-joint portion 51b (FIG. 2A). For this reason, the core 2 easily adheres to the surface 53b of the joint portion 50b, and accordingly, the joint strength between the joint portion 50b and the core 2 can be improved.

Incidentally, a difference between the surface roughness of the surface 53b of the joint portion 50b and the surface roughness of the surface of the non-joint portion 51b (FIG. 2A) was confirmed by cutting the core 2 around the joint portion 50b using a cutting tool (further destroying the core 2 using heat) and by observing the joint portion 50b exposed by the cutting, using a laser microscope or observing a cross section using a scanning electron microscope.

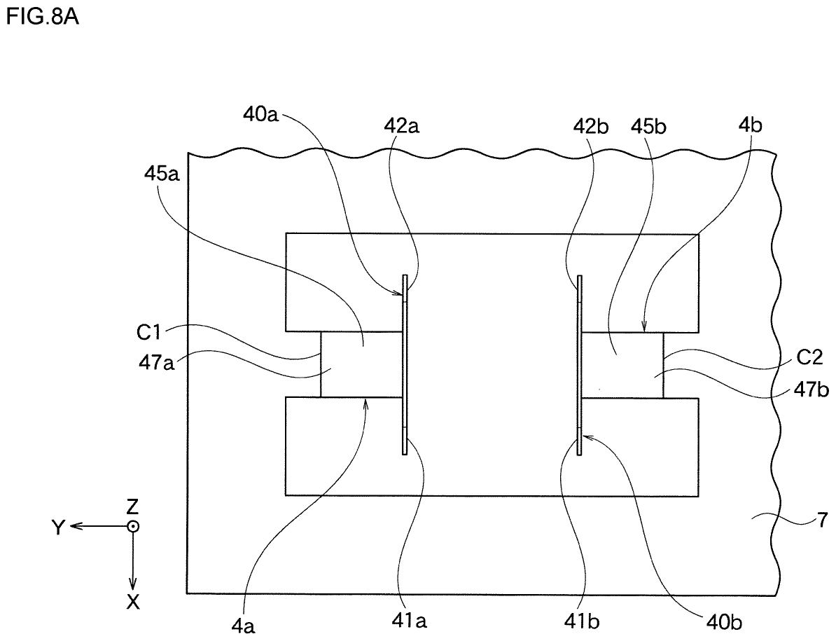

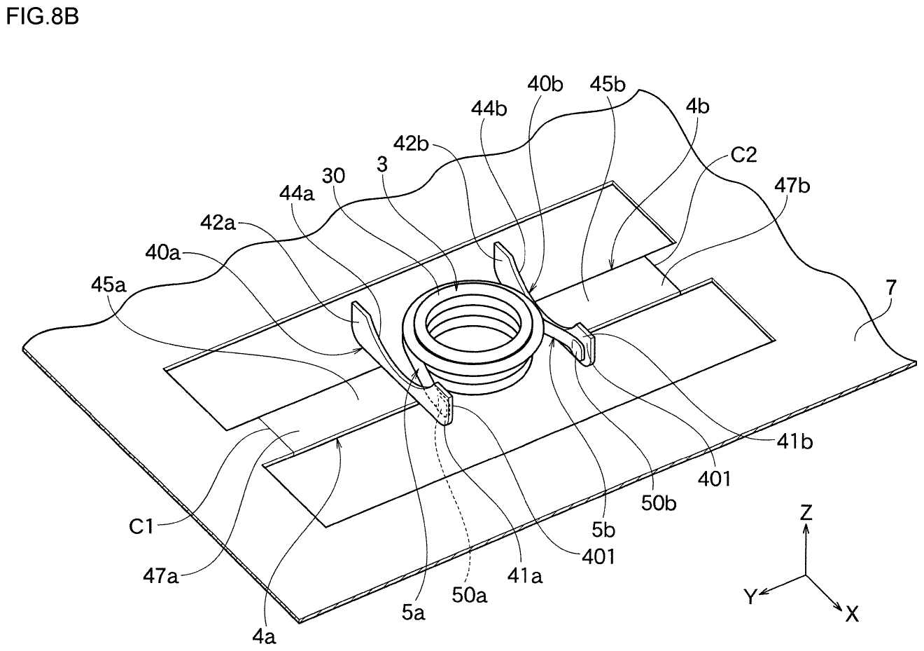

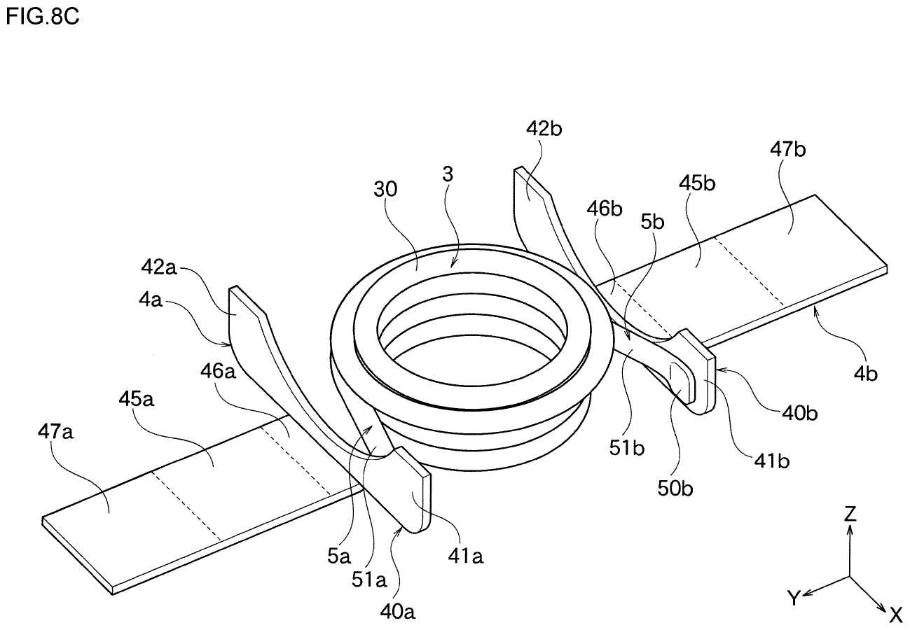

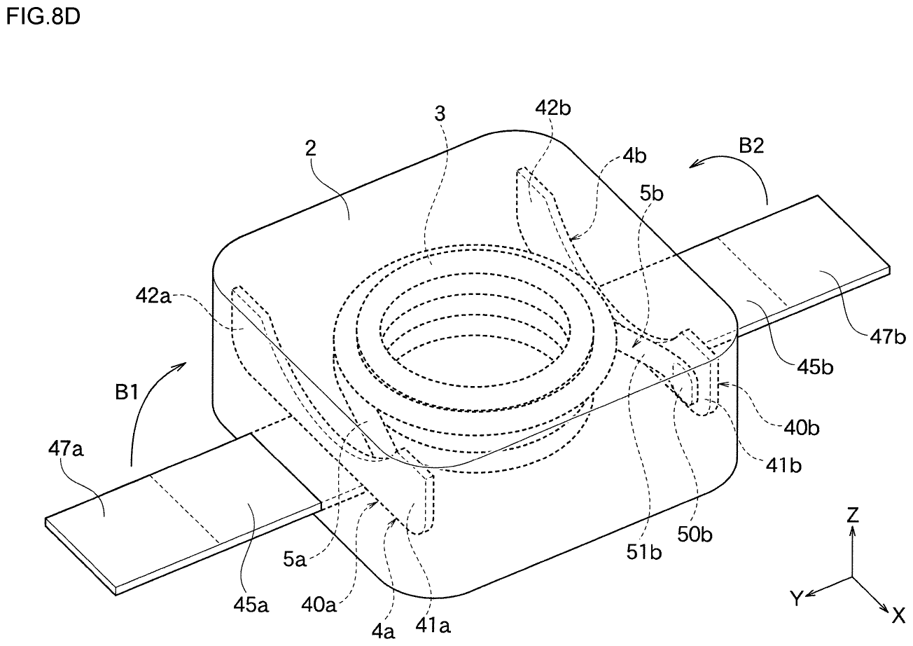

Next, a method for manufacturing the coil device 1 will be described with reference to FIGS. 8A to 8D. First, a conductive plate such as a metal plate is punched into a shape illustrated in FIG. 8A to form a frame 7 including the terminal 4a and the terminal 4b. Incidentally, the terminal 4a and the terminal 4b in a state where the first connection portion 45a, the first connection portion 45b, the external electrode portion 47a, and the external electrode portion 47b are not bent and formed are formed in the frame 7 (refer to FIG. 4).

The metal layers 60 each including the first metal layer 61 and the second metal layer 62 (FIG. 7A) may be each formed on surfaces of the terminal 4a and the terminal 4b. The metal layers 60 can be formed, for example, by applying a plating process to surfaces of the terminal 4a and the terminal 4b.

Next, as illustrated in FIG. 8B, the coil 3 is disposed between the wire connection portion 40a and the wire connection portion 40b. Next, an end portion in an extending direction of the lead-out portion 5a is joined to the first wire connection piece 41a of the terminal 4a, for example, by thermocompression joining. Similarly, an end portion in the extending direction of the lead-out portion 5b is joined to the first wire connection piece 41b of the terminal 4b. Incidentally, insulation coatings of the end portions in the extending direction of the lead-out portions 5a and 5b may be removed in advance.

During thermocompression joining, the end portions in the extending direction of the lead-out portion 5a and the lead-out portion 5b are pushed against the first surfaces 401 of the first wire connection piece 41a and the first wire connection piece 41b, and pressure is applied thereto. Accordingly, the end portions in the extending direction of the lead-out portion 5a and the lead-out portion 5b are crushed to form the joint portion 50a and the joint portion 50b having a substantially flattened shape. The joint portion 50a and the joint portion 50b are disposed substantially parallel to the winding axis of the coil 3.

Next, the terminal 4a is cut along a cutting line C1 and the terminal 4b is cut along a cutting line C2 to form an assembly of the coil 3, the terminal 4a, and the terminal 4b illustrated in FIG. 8C.

Next, the assembly illustrated in FIG. 8C is installed in a press mold, and the inside of the press mold is filled with a magnetic material (composite magnetic material using thermoplastic resin or thermosetting resin as a binder) constituting the core 2 (FIG. 2A). Then, together with the wire connection portion 40a and the wire connection portion 40b to which the lead-out portion 5a and the lead-out portion 5b are joined, the coil 3 is covered with the magnetic material and is compression-molded. Accordingly, as illustrated in FIG. 8D, a green compact in which the coil 3 is embedded together with the wire connection portion 40a and the wire connection portion 40b can be obtained.

Next, the first connection portion 45a, the first connection portion 45b, the external electrode portion 47a, and the external electrode portion 47b protruding outside the green compact are bent in directions indicated by arrow B1 and arrow B2. Then, the first connection portion 45a is disposed on the third surface 2c of the core 2 illustrated in FIG. 2A, and the external electrode portion 47a is disposed on the fifth surface 2e. In addition, the first connection portion 45b is disposed on the fourth surface 2d of the core 2, and the external electrode portion 47b is disposed on the fifth surface 2e. The coil device 1 can be obtained in such a manner described above.

In the coil device 1 of the present embodiment, as illustrated in FIG. 2A, the wire connection portion 40a and the wire connection portion 40b are disposed substantially parallel to the winding axis of the coil 3. For this reason, the protrusion of the wire connection portion 40a and the wire connection portion 40b into the magnetic flux path is reduced, so that the overlapping between the magnetic flux path and each of the wire connection portion 40a and the wire connection portion 40b is suppressed. Accordingly, the wire connection portion 40a and the wire connection portion 40b are less likely to obstruct a magnetic flux flow, so that the inductance characteristics of the coil device 1 can be improved.

In addition, the thickness L1 of the joint portion 50a and the joint portion 50b is smaller than the thickness L2 of the non-joint portion 51a and the non-joint portion 51b. For this reason, the joint portion 50a and the joint portion 50b are in the state of being compressed in the thickness direction, so that the first wire connection piece 41a and the first wire connection piece 41b can be compactly joined to the joint portion 50a and the joint portion 50b. As a result, the volume of the core 2 that can be disposed around the joint portion 50a and the joint portion 50b is increased, so that the inductance characteristics of the coil device 1 can be improved.

### Second Embodiment

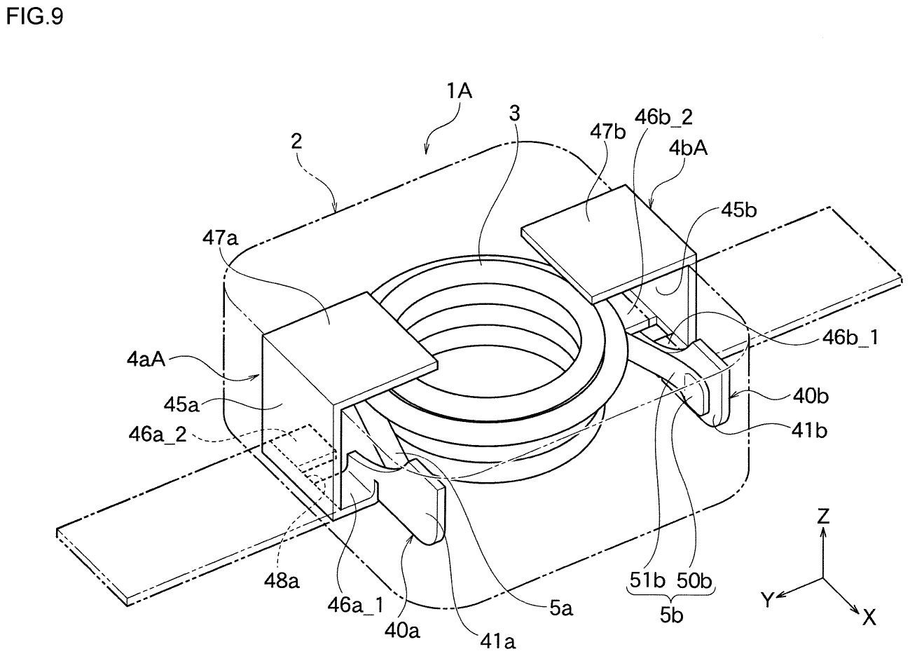

A coil device 1A of a second embodiment illustrated in FIG. 9 has the same configuration as the coil device 1 of the first embodiment, except for the following points. In FIG. 9, members that overlap with the coil device 1 of the first embodiment are denoted by the same letters or numerals, and a detailed description thereof will be omitted.

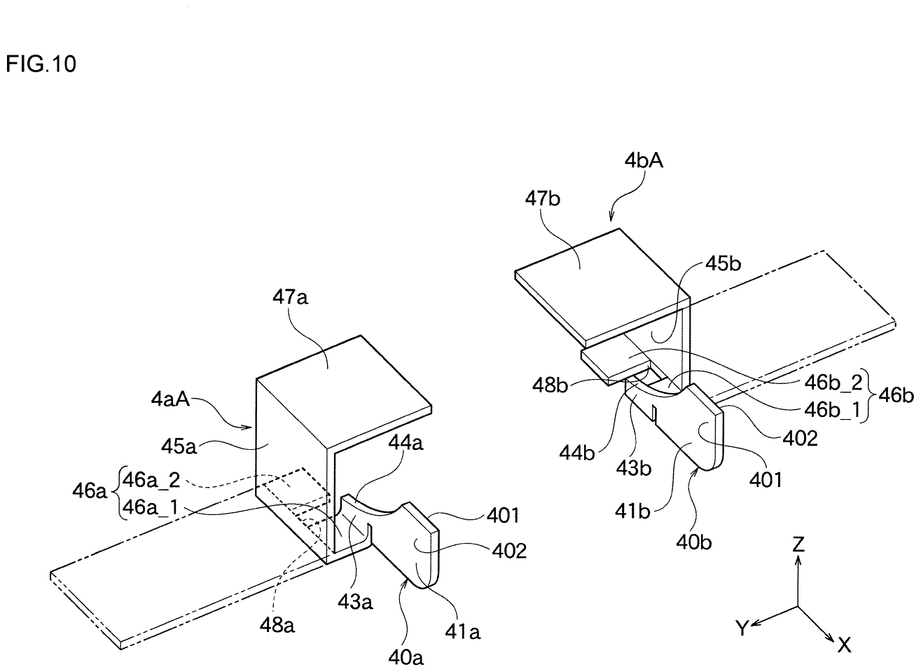

As illustrated in FIG. 9, the coil device 1A is different from the coil device 1 in the first embodiment (FIG. 2A) in that the coil device 1A includes a terminal 4aA and a terminal 4bA. As illustrated in FIG. 10, the terminal 4aA and the terminal 4bA are not provided with the second wire connection piece 42a and the second wire connection piece 42b (FIG. 4). In addition, the intermediate portion 43a and the intermediate portion 43b are partially omitted from the terminal 4aA and the terminal 4bA, together with the second wire connection piece 42a and the second wire connection piece 42b. On the other hand, the terminal 4aA and the terminal 4bA include a groove portion 48a and a groove portion 48b.

The groove portion 48a and the groove portion 48b are formed in the second connection portion 46a and the second connection portion 46b, respectively, and extend along the Y-axis direction. A second connection portion 46a_1 is formed on one side in the X-axis direction with respect to the groove portion 48a, and a second connection portion 46a_2 is formed on the other side in the X-axis direction with respect to the groove portion 48a. Namely, the second connection portion 46a is divided into the second connection portion 46a_1 and the second connection portion 46a_2. The second connection portion 46b has the same configuration as the second connection portion 46a, and is divided into a second connection portion 46b_1 and a second connection portion 46b_2. By forming the groove portion 48a and the groove portion 48b in the second connection portion 46a and the second connection portion 46b, respectively, the bending of the first wire connection piece 41a and the first wire connection piece 41b is easily performed at the positions of the second connection portion 46a and the second connection portion 46b.

Even in the present embodiment, the same effects as in the first embodiment can be obtained. In addition, in the present embodiment, since the second wire connection piece 42a, the second wire connection piece 42b, and the like are omitted from the terminal 4aA and the terminal 4bA, the configuration of the terminal 4aA and the terminal 4bA can be simplified, and the manufacturing of the coil device 1A can be facilitated.

### Third Embodiment

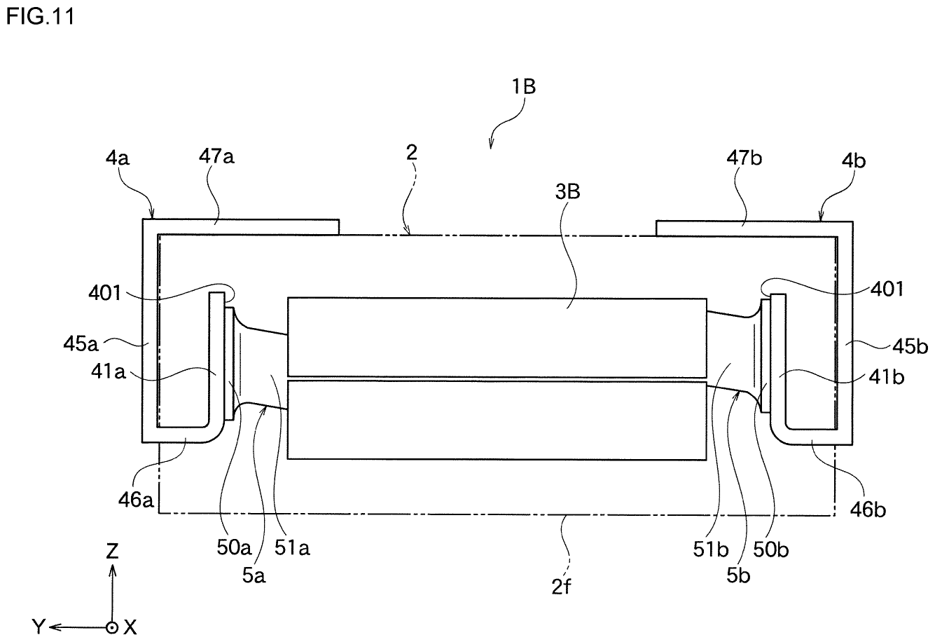

A coil device 1B of a third embodiment illustrated in FIG. 11 has the same configuration as the coil device 1 of the first embodiment, except for the following points. In FIG. 11, members that overlap with the coil device 1 of the first embodiment are denoted by the same letters or numerals, and a detailed description thereof will be omitted.

The coil device 1B is different from the coil device 1 in the first embodiment (FIG. 2A) in that the coil device 1B includes a coil 3B. The coil 3B is made of a rectangular wire wound in a flatwise manner. The coil 3B may be made of a rectangular wire wound in an edgewise manner. The joint portion 50a and the joint portion 50b have a substantially flattened shape (plate shape) in a Y-Z cross section. Incidentally, similarly, the non-joint portion 51a and the non-joint portion 51b have a substantially flattened shape.

Even in the present embodiment, the same effects as in the first embodiment can be obtained. In addition, in the present embodiment, a wide surface of the rectangular wire forms joining surfaces of the joint portion 50a and the joint portion 50b. For this reason, the joining areas between the joint portion 50a and the first wire connection piece 41a and between the joint portion 50b and the first wire connection piece 41b are increased, so that the joint stability therebetween can be improved.

Incidentally, the present application is not limited to the above-described embodiments, and various modifications can be made without departing from the scope of the present application.

In each of the embodiments, an example of applying the coil device 1 to an inductor has been described, but the coil device 1 may be an electronic component other than an inductor.

In the first embodiment, as illustrated in FIGS. 2AB and 4, the width L3 of the joint portion 50a and the joint portion 50b is smaller than the width L6 of the first wire connection piece 41a and the first wire connection piece 41b (FIG. 4), but the width L3 may be equal to or greater than the width L6. The same applies to the second embodiment and the third embodiment.

In the first embodiment, as illustrated in FIG. 2A, the joint portion 50a and the joint portion 50b are joined to the first surfaces 401 of the first wire connection piece 41a and the first wire connection piece 41b, but may be joined to the second surfaces 402. The same applies to the second embodiment and the third embodiment.

In the first embodiment, as illustrated in FIG. 5A, the external electrode portion 47a and the external electrode portion 47b are disposed on the fifth surface 2e of the core 2, but as illustrated in FIG. 5B, the external electrode portion 47a and the external electrode portion 47b may be disposed on the sixth surface 2f of the core 2. The same applies to the second embodiment and the third embodiment.

In the first embodiment, the joint portion 50a and the joint portion 50b may be joined to the first wire connection piece 41a and the first wire connection piece 41b by a method other than thermocompression joining (for example, laser welding).

### EXPLANATIONS OF LETTERS OR NUMERALS

1, 1A, 1B COIL DEVICE
2 CORE
3, 3B COIL
30 WINDING PORTION
4a, 4b, 4aA, 4bA TERMINAL
40a, 40b WIRE CONNECTION PORTION
401 FIRST SURFACE
402 SECOND SURFACE
403 CONCAVE PORTION
41a, 41b FIRST WIRE CONNECTION PIECE
42a, 42b SECOND WIRE CONNECTION PIECE
43a, 43b INTERMEDIATE PORTION
44a, 44b CURVED PORTION
45a, 45b FIRST CONNECTION PORTION
46a, 46b, 46a_1, 46b_1, 46a_2, 46b_2 SECOND CONNECTION PORTION
47a, 47b EXTERNAL ELECTRODE PORTION
48a, 48b GROOVE PORTION
5a, 5b LEAD-OUT PORTION
50a, 50b JOINT PORTION
51a, 51b NON-JOINT PORTION
52b JOINING SURFACE
53b SURFACE
54 IRREGULARITIES
6 METAL LAYER
61 FIRST METAL LAYER
62 SECOND METAL LAYER
620 ADHESION PORTION
7 FRAME

What is claimed is:

1. A coil device comprising:
a core;
a coil including a winding portion disposed inside the core, and a lead-out portion led out from the winding portion; and
a terminal including a wire connection portion joined to the lead-out portion and disposed inside the core,
wherein the wire connection portion is disposed substantially parallel to a winding axis of the coil.

2. The coil device according to claim 1,
wherein the wire connection portion is disposed substantially parallel to one surface or the other surface of the core, the one surface and the other surface facing each other in a direction substantially perpendicular to the winding axis.

3. The coil device according to claim 2,
wherein a part of the terminal is exposed from the one surface or the other surface of the core, and
the wire connection portion is disposed substantially parallel to the one surface or the other surface of the core.

4. The coil device according to claim 1,
wherein an end portion on one side of the wire connection portion with respect to a winding axis direction of the coil is disposed at a position substantially equal to a position of an end portion on the one side of the coil.

5. The coil device according to claim 1,
wherein the lead-out portion is joined to a first surface of the wire connection portion, the first surface facing the coil.

6. The coil device according to claim 1,
wherein the core includes a corner at which a plurality of surfaces disposed substantially parallel to the winding axis of the coil intersect each other, and
at least a part of the wire connection portion is located at the corner.

7. The coil device according to claim 6,
wherein the corner includes a first corner and a second corner located opposite to the first corner along a direction substantially perpendicular to the winding axis of the coil,
the wire connection portion includes a first wire connection piece to which the lead-out portion is joined, and a second wire connection piece located opposite to the first wire connection piece along the direction substantially perpendicular to the winding axis of the coil, and
the first wire connection piece is disposed at the first corner, and the second wire connection piece is disposed at the second corner.

8. The coil device according to claim 1,
wherein the lead-out portion is biased by an elastic force of the lead-out portion so as to press the wire connection portion.

9. The coil device according to claim 1,
wherein the lead-out portion includes a joint portion joined to the wire connection portion,
the coil is made of a rectangular wire wound in a flatwise manner, and
a wide surface of the rectangular wire forms a joining surface of the joint portion to the wire connection portion.

10. The coil device according to claim 1,
wherein the lead-out portion includes a joint portion joined to the wire connection portion, and a non-joint portion separated from the joint portion, and
a first thickness of the joint portion is smaller than a second thickness of the non-joint portion.

11. The coil device according to claim 10,
wherein a third thickness of the wire connection portion is larger than the first thickness of the joint portion.

12. The coil device according to claim 10,
wherein a first width of the joint portion is larger than a second width of the non-joint portion.

13. The coil device according to claim 12,
wherein a third width of the wire connection portion is larger than the first width of the joint portion.

14. The coil device according to claim 1,
wherein the terminal includes a first terminal and a second terminal,
the wire connection portion includes a first wire connection portion provided in the first terminal, and a second wire connection portion provided in the second terminal,
the lead-out portion includes a first lead-out portion and a second lead-out portion, and
the first lead-out portion and the second lead-out portion are joined to the first wire connection portion and the second wire connection portion, respectively, on the same side in a first direction of the core.

15. The coil device according to claim 14,
wherein the first lead-out portion and the second lead-out portion are joined to one end portion in the first direction of the first wire connection portion and one end portion in the first direction of the second wire connection portion, respectively.
